(19) United States
(12) Patent Application Publication
(10) Pub. No.: US 2023/0315610 A1
(43) Pub. Date: Oct. 5, 2023

(54) COMPUTER-IMPLEMENTED METHOD FOR VERIFYING A SOFTWARE COMPONENT OF AN AUTOMATED DRIVING FUNCTION

(71) Applicant: Robert Bosch GmbH, Stuttgart (DE)

(72) Inventors: Christian Heinzemann, Vellmar (DE); Lukas Koenig, Grossbottwar (DE); Michael Hanselmann, Korntal-Muenchingen (DE)

(21) Appl. No.: 18/178,767

(22) Filed: Mar. 6, 2023

(30) Foreign Application Priority Data
Mar. 30, 2022 (DE) 10 2022 203 123.7

(51) Int. Cl. G06F 11/36; G06F 8/10

(52) U.S. Cl. CPC G06F 11/3608; G06F 8/10

(57) ABSTRACT

A computer-implemented method for verifying at least one software component of an automated driving function. The software component to be verified includes at least one function which uses sensor information from at least one sensor. The method includes: a. providing a model for the software component to be verified, b. providing at least one sensor performance model for the at least one sensor, c. generating an overall model, in the process of which the at least one sensor performance model is combined with the model of the software component to be verified, d. analyzing the overall model using a model checking method.

### CROSS REFERENCE

The present application claims the benefit under 35 U.S.C. § 119 of German Patent Application No. DE 10 2022 203 123.7 filed on Mar. 30, 2022, which is expressly incorporated herein by reference in its entirety.

### FIELD

The present invention relates to a computer-implemented method for verifying a software component of an automated driving function, the software component to be verified including at least one function which utilizes sensor information. This sensor information is made available by at least one sensor.

### BACKGROUND INFORMATION

Within the framework of the industrial development process of software components of an automated driving function such as behavior planners, fusion algorithms and other control modules, the correctness of the implementation must be verified. At present, this verification is usually based on tests, for which methods such as simulation-based testing or replay-HiL (hardware in the loop) solutions are used. However, test-based methods basically do not guarantee that errors are discovered or that the tested software component is free of errors.

Techniques and tools for model checking and probabilistic model checking are described in scientific literature. A model checker checks all possible embodiments of a software or a model of the software against a mathematically precisely formulated requirement. In the process, it is checked whether all possible embodiments of the software satisfy the requirement. In this way, it can be shown in a mathematically formalistic way whether the software or the model of the software is free of errors with regard to the formulated requirement. In this context, Spin (http://spinroot.com/spin/whatispin.html) and NuSMV (http://nusmv.fbk.eu/) are examples of model checking tools.

Probabilistic model checking considers the occurrence probability or probability distribution of inputs into the software to be verified. This information about the probabilities may be used to calculate a probability of the correctness of the software. If the software is able to handle all incoming information without error, the probability of the correctness is 1.0. Here, PRISM (https://www.prismmodelchecker.org/) and STORM (https://www.stormchecker.org/) are examples of probabilistic model checking tools.

These model checking tools are generic tools which have not been designed for a specific purpose, but are used within the scope of the present invention described in the following text.

### SUMMARY

The present invention provides measures that enable a reliable verification of software components even if these software components access sensor information whose quality and meaningfulness greatly depend on the performance of the respective sensor. Nevertheless, with the aid of the method according to the present invention, the correctness of such a software component can be checked with regard to predefined requirements and, ideally, can also be verified.

A computer-implemented method according to an example embodiment of the present invention for verifying a software component of an automated driving function includes the following steps:
Providing a model for the software component to be verified,
Providing at least one sensor performance model for the at least one sensor,
Generating an overall model, in the context of which the at least one sensor performance model is combined with the model of the software component to be verified,
Analyzing the overall model using a model checking method.

According to the present invention, it was recognized that model checking tools may also be used within the framework of verifying software components of an automated driving function. In contrast to the conventional testing methods, model checking methods then even provide formal mathematical proof of an error-free implementation of the software component with regard to the previously formulated requirements. For this reason, a model for the software component to be verified is provided according to the present invention, to which the model checking tools can be applied. It was furthermore recognized according to the present invention that within the scope of a verification with the aid of model checking, it can also be taken into account that the sensor information required as input information by the software component to be verified may include random errors. To this end, according to the present invention, a sensor performance model is generated for the corresponding sensor and combined with the model for the software component to be verified. In this way, the model checking method makes it possible to check for all possible implementations of the software component whether their behavior remains correct during the occurrence of any possible input errors or whether an error results.

A sensor performance model should describe at least one performance error of a sensor of the overall system that forms the basis of the automated driving function. Within the framework of the method according to an example embodiment of the present invention, it is possible to use sensor performance models that have been set up by a human modeler or also automatically generated sensor performance models. It is particularly advantageous if at least one of the used sensor performance models is automatically generated on the basis of at least one performance measurement of the corresponding sensor of the overall system. In all cases, the sensor performance models are then automatically combined with the model of the software component to be verified, and an analysis is carried out with the aid of a model checking method so that the correctness of the system can be checked and, ideally, verified.

With the aid of the method according to an example embodiment of the present invention, the influence of sensors of different types on the software component is able to be taken into account. Inertial sensors and vehicle environment sensors are of special importance within the framework of automated driving functions.

According to an example embodiment of the present invention, an inertial sensor could provide sensor information to the software component to be verified in the form of the sensor signal as such or also in the form of higher-quality information derived from the sensor signal such as trajectory information. If the supplied sensor information involves the sensor signal as such, then the sensor performance model of the inertial sensor could describe the production-related sensor performance. If the software component to be verified receives higher-quality information, then the sensor performance model of the inertial sensor could model the reliability of this higher-quality information.

In the context of automated driving functions, the sensor signals from vehicle environment sensors such as radar sensors, lidar sensors, ultrasonic sensors, microphones and cameras are usually evaluated to detect objects of object classes defined in advance. As sensor information, the software component to be verified is then supplied with information about the presence of such objects in the vehicle environment. In this case, the sensor performance model is advantageously derived from measured detection probabilities for the detection of individual objects of the previously defined object classes.

In one especially advantageous variant of the method according to the present invention, a domain model is provided, which describes influence factors on the sensor performance, in particular influence factors caused by the environment. This domain model is considered during the generation of the at least one sensor performance model in that the at least one sensor performance model is generated on the basis of performance measurements with different manifestations of the influence factors. The domain model describes influence factors on the operating environment of the overall system in machine-readable form. Examples of such influence factors in the context of a vehicle environment sensor are the weather conditions, the ambient brightness, the sun position, or contrast conditions. This makes it possible to ascertain conditional probabilities for the sensor errors on the basis of which the behavior of the overall system, and thus also of the software component to be verified, is able to be verified in a more precise manner under different environmental influences.

Within the framework of the method according to the present invention, a memoryless or a state-based model is able to be used as a model for the software component to be verified and/or as a sensor performance model, in particular:
a finite state automaton (Finite State Model (FSM))
a timed state automaton,
a probability-based state automaton,
a Markov chain,
a (partially observable) Markov decision process, or
a Petri net,
or a mixed form of multiple of the aforementioned model types.

Generally, a software component to be verified is merely part of an overall system for realizing an automated driving function. In most cases, this overall system has further system components which supply input data for the software component to be verified and/or accept output data of the software component to be verified. It is advantageous in such a constellation if the model of the software component to be verified together with the at least one sensor performance model is combined with the models of these further system components when the overall model is generated. This makes it possible to also consider reciprocal effects with further system components in the verification of the software component.

A special advantage of the analysis of the overall model according to the present invention with the aid of a model checking method is that such an analysis supplies formal mathematical evidence or proof of the correctness of the software component to be verified, provided the implementation of the software component with regard to a previously defined requirement is correct. In one advantageous embodiment of the present invention, the analysis according to the present invention otherwise supplies at least one counterexample for the correctness. This is extremely helpful, especially during the development process, because the error search is made considerably easier by such counterexamples.

According to an example embodiment of the present invention, during the analysis of the overall model with the aid of model checking, it is also checked whether, and possibly under what environmental conditions, performance deficits of at least one sensor can be compensated for by the performance of at least one further sensor, so that the software component to be verified supplies correct results.

In one especially preferred example embodiment of the present invention, a probabilistic model checking method is used to analyze the overall model. In the process, probabilities that the software component to be verified delivers correct results are ascertained on the basis of the at least one sensor performance model. In this method variant, too, the model checking method checks for all possible embodiments of the software component to be verified whether their behavior remains correct during the occurrence of any possible input errors or whether an error results. In the latter case, the information about the probability and/or the distribution function of the errors is utilized to calculate the probability at which the software component to be verified produces a correct result.

### BRIEF DESCRIPTION OF THE DRAWINGS

Advantageous example embodiments and further refinements of the present invention will be described in the following text based on the figures.

FIG. 1 illustrates a method according to an example embodiment of the present invention with the aid of a block diagram.

FIG. 2 shows an example of a domain model, according to the present invention.

### DETAILED DESCRIPTION OF EXAMPLE EMBODIMENTS

A computer-implemented method according to the present invention is used for the verification of a software component which contributes to the realization of an automated driving function and uses sensor information from at least one sensor for this purpose. Such a software component, for example, could involve a behavior planner or also a fusion algorithm which processes and possibly evaluates sensor information from a plurality of sensors in order to generate higher-quality information therefrom.

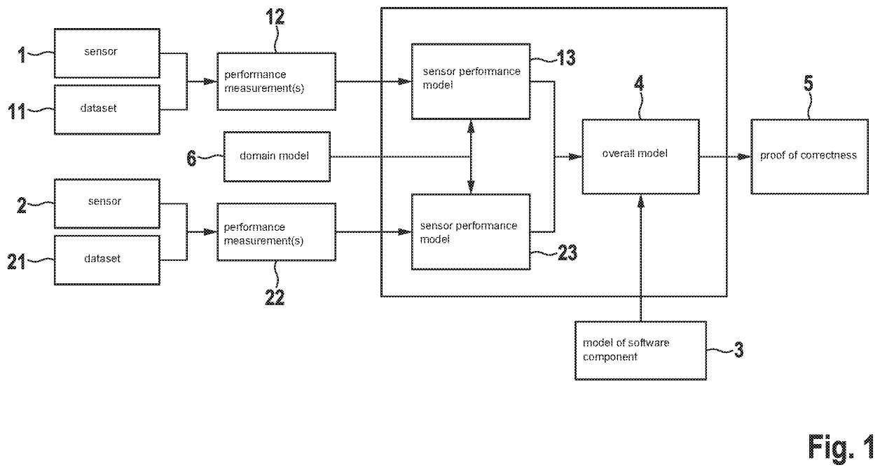

According to the method of the present invention, a model of the software component to be verified is supplied, which is denoted by 3 in FIG. 1. This could involve a memoryless or a state-based model 3, in particular a finite state automaton (finite state model (FSM)), a timed state automaton, a probability-based state automaton, a Markov chain, a fully or partly observable Markov decision process, or a Petri net or also a mixed form of a multiplicity of the previously mentioned model types.

In the illustrated exemplary embodiment, two sensors 1 and 2 are provided, which supply sensor information to the software component to be verified. As a matter of principle, however, any number of sensors may supply sensor information for the software component to be verified, these sensors possibly involving both vehicle environment sensors of a different sensor modality and inertial sensors. Sensors 1, 2 of the exemplary embodiment described here involve vehicle environment sensors of the video and radar type that are used for an object detection. To this end, each one of sensors 1, 2 includes a perception component, which evaluates the actual sensor signals with regard to the detection of objects of predefined object classes and makes the result of this evaluation available in the form of sensor information. For instance, traffic signs, traffic lights or cars may be defined as object classes.

It is essential here that a separate dataset 11, 21 exists for each sensor 1, 2, with the aid of which the performance of the respective perception component is able to be determined. This is because in the described variant of the method according to the present invention, such a performance measurement 12, 22 is carried out for each sensor 1, 2 in order to determine detection probabilities for the individual object classes for each sensor 1, 2. From the results of performance measurements 12, 22, a sensor performance model 13, 23 is then automatically derived for each sensor 1, 2, which describes the detection quality for each object class, that is, how well an object of a certain class is detected by the perception component of respective sensor 1, 2. If possible, sensor performance models 13 and 23 are constructed in the same format as model 3 of the software component to be verified, that is, in the form of one of the previously mentioned memoryless or state-based models. This is so because the present invention provides for the combination of model 3 of the software component to be verified and sensor performance models 13 and 23 so that the resulting overall model 4 can be analyzed using a model checking method.

It is frequently useful to incorporate still further models of additional system components into overall model 4, at least if these further system components supply input data for the software component to be verified and/or receive output data of the software component to be verified. For reasons of clarity, a corresponding illustration has been omitted in FIG. 1.

The model checking method then automatically supplies proof 5 of the correctness of the software component to be verified with regard to previously defined requirements. More specifically, in this type of analysis of the overall model, it is also checked whether, and possibly under what conditions, performance deficits of the one sensor 1 or 2 are able to be compensated for by the performance of other sensor 2 or 1 so that the software component to be verified supplies correct results. In the event that the results of the software component to be verified do not satisfy the previously defined requirements in all embodiments, the model checking method, in one advantageous embodiment of the present invention, supplies at least one counterexample for the correctness, that is, a sensor constellation in which the requirements are not satisfied.

If a probabilistic model checking method is used to analyze overall model 4, then probabilities that the software component to be verified supplies correct results are ascertained on the basis of the sensor performance models 13, 23.

In the variant of the method according to the present invention illustrated by FIG. 1, a manually provided domain model 6 is taken into account during the automatic generation of sensor performance models 13 and 23. Domain model 6 is used to enrich the sensor performance models 13, 23 in that it describes essential influence factors on the sensor performance, in particular environment-related influence factors. In the case of video sensor 1, these are weather and illumination conditions, for instance. Domain model 6 is used to individually determine the performance of sensors 1, 2 for every possible manifestation of each individual influence factor. For the influence factor ‘time of day’ in the present example, this would be the manifestations ‘sunrise’, ‘day’, ‘sunset’ and ‘night’. The sensor performance models 13, 23 obtained in this way are considerably more specific and precise than models that fail to consider such environment-related influence factors. This particularly makes it possible to examine whether other sensors are able to compensate for performance deficits of individual sensors under certain environment conditions and produce a correct behavior of the system or the software component to be verified in all possible combinations.

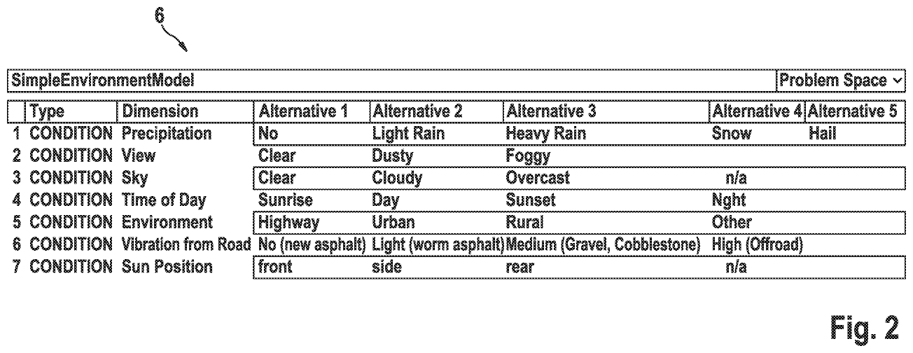

One example of a section of such a domain model 6 in the form of a SCODE (System Co-Design) model is shown in FIG. 2. However, such a domain model may also be available in the form of an ontology, a labeling hierarchy, or other suitable formats.

In conclusion, it should also be expressly mentioned that in addition to the previously described method for verifying a software component of an automated driving function, a software component verified according to the present invention and a computer-implemented system for realizing an automated driving function, which includes at least one software component verified according to the present invention, are also a subject matter of the present invention.

The method according to the present invention is preferably used at the time when systems for realizing an automated driving function are designed to check the correctness of behavior planners, sensor fusion components or also other control modules. These may be semiautomated or fully automated driving functions, which adapt their behavior based on sensor information that includes errors. This particularly relates to driver assistance systems, highly automated driving functions, robots, airplane controls, autonomous ships, etc.

What is claimed is:

1. A computer-implemented method for verifying at least one software component of an automated driving function, the software component to be verified includes at least one function which uses sensor information, and the sensor information is made available by at least one sensor, the method comprising the following steps:
a. providing a model for the software component to be verified;
b. providing at least one sensor performance model for the at least one sensor;
c. generating an overall model including the at least one sensor performance model combined with the model of the software component to be verified; and
d. analyzing the overall model using a model checking method.

2. The method as recited in claim 1, wherein the at least one sensor performance model is generated based on at least one performance measurement on the at least one sensor so that it describes a corresponding performance error of the at least one sensor.

3. The method as recited in claim 1, wherein the at least one sensor is a vehicle environment sensor including a radar sensor or a lidar sensor or an ultrasonic sensor or a microphone or a camera, and the vehicle environment sensor detects objects of object classes defined in advance and supplies information about a presence of the objects in the vehicle environment as sensor information, wherein detection probabilities for the detection of the objects are determined within a framework of the performance measurement.

4. The method as recited in claim 1, wherein a domain model is provided, which describes influence factors on the sensor performance including environment-related influence factors, and the domain model is considered when the at least one sensor performance model is generated in that the at least one sensor performance model is generated based on the performance measurements with different manifestations of the influence factors.

5. The method as recited in claim 1, wherein a memoryless model or a state-based model is used as the model for the software component to be verified and/or as the sensor performance model, the memoryless model or the state-based model including:
a finite state automaton, or
a timed state automaton, or
a probabilistic state automaton, or
a Markov chain, or
a partially observable Markov decision process, or
a Petri net, or
a mixed form of multiple of the finite state automaton, the timed state automaton, the probabilistic state automaton, the partially observable Markov decision process or the Petri net.

6. The method as recited in claim 1, wherein the model of the software component to be verified together with the at least one sensor performance model is combined during generation of the overall model with additional models of further system components, which provide input data for the software component to be verified and/or accept output data of the software component to be verified.

7. The method as recited in claim 1, wherein the analysis of the overall model supplies proof of correctness of the software component to be verified and/or at least one counterexample for the correctness.

8. The method as recited in claim 1, wherein it is checked during the analysis of the overall model whether, and under what environmental conditions, performance deficits of at least one sensor can be compensated for by the performance of at least one further sensor so that the software component to be verified supplies correct results.

9. The method as recited in claim 1, wherein the overall model is analyzed using a probabilistic model checking method, in the context of which probabilities that the software component to be verified supplies correct results are ascertained based on the at least one sensor performance model.

10. A software component of an automated driving function, the software component including at least one function which uses sensor information, and the sensor information is made available by at least one sensor, wherein the software component has been verified by:
a. providing a model for the software component to be verified;
b. providing at least one sensor performance model for the at least one sensor;
c. generating an overall model including the at least one sensor performance model combined with the model of the software component to be verified; and
d. analyzing the overall model using a model checking method.

11. A computer-implemented system for realizing an automated driving function, which includes at least one software component including at least one function which uses sensor information, and the sensor information is made available by at least one sensor, wherein the software component has been verified by:
a. providing a model for the software component to be verified;
b. providing at least one sensor performance model for the at least one sensor;
c. generating an overall model including the at least one sensor performance model combined with the model of the software component to be verified; and
d. analyzing the overall model using a model checking method.
